(19) United States
(12) Patent Application Publication
(10) Pub. No.: US 2005/0242052 A1
(43) Pub. Date: Nov. 3, 2005

(54) Method and apparatus for gantry crane sway determination and positioning

(76) Inventors: Michael L. O'Connor, Redwood City, CA (US); David G. Lawrence, Mountain View, CA (US); Avi N. Gross, Palo Alto, CA (US); Ethan A. Frantz, Menlo Park, CA (US); Robert C. Melhorn JR., Mountain View, CA (US)

Correspondence Address: Greg H. Leitich, P.O. Box 3255, Austin, TX, 78764, US

(21) Appl. No.: 10/837,445

(22) Filed: Apr. 30, 2004

(51) Int. Cl. B66C 19/00

(52) U.S. Cl. 212/344

(57) ABSTRACT

A gantry crane system includes a frame structure having a plurality of vertical support legs and one or more members interconnecting predetermined pairs of the vertical support legs; and a positioning system including positioning sensors mounted to the frame structure and configured to receive positioning signals from positioning transmitters and a position processing unit configured to use the positioning signals to determine a deflection from vertical of at least one of the vertical support legs. In certain embodiments, the gantry crane system further includes a grappler assembly mounted to the frame structure. The position processing unit is configured to use the positioning signals to determine a location of the grappler assembly.

### BACKGROUND OF THE INVENTION

1. Field of the Invention

The present invention is directed generally to gantry crane systems and, particularly, to an improved system and method for gantry crane positioning.

2. Description of the Related Art

In intermodal yards, ports, railyards, and other facilities (collectively referred to as “container handling yards”), shipping containers are typically handled by gantry cranes. Such gantry cranes usually have a frame with vertical support legs and one or more interconnecting and typically horizontal members. A hoisting system or grappler is usually mounted in a moveable and elevated position on the frame from one or more of the horizontal members. The crane may be equipped with wheels and a drive system to enable moving the crane around the container handling yard and to position the gantry crane over the container or stack of containers to be handled. The grappler may then be lowered to lift the container.

Precise steering of the gantry crane is desired for reasons of efficiency, cost and safety. Container handling yards are usually tightly packed, and drivers are occasionally not able to steer cranes to required accuracies. Vehicle maneuvering in such situations can delay the job that the driver is trying to do, and can even lead to collisions with other vehicles or objects. Also, when a vehicle is driven off of the desired path, which is often made of reinforced concrete, damage can occur to the yard.

As can be appreciated, a gantry crane can be of considerable size. For example, the gantry crane frame may be more than sixty (60) feet high. Consequently, considerable sway or deflection of the frame supports and members can occur. This can lead to a significant difference (on the order of many inches) between the position of the top of the gantry crane and the wheels and, thus, inaccuracy in control.

Automatic gantry crane steering systems based on global positioning system (GPS) technology have been developed. PCT Publication WO 98/34127 describes a system employing two GPS antennas and two GPS receivers to measure the position and heading of a shipyard crane. However, the system described therein is suitable for use only if the crane moves in straight lines. Further, the GPS antennas are in an elevated position at the top of the crane, and the PCT publication does not take into account vehicle sway that can cause significant errors in determining the position of the wheels.

In addition to controlling the steering of a rubber tire gantry crane, precise sensing and control of mechanisms on any type of gantry crane (rubber tire, rail based, straddle carrier, or stationary) is often desirable. For example, when using certain methods of container tracking, it is desirable to know the precise location of the grappler with respect to inertial space. This allows the container tracking system to know precisely where a container is picked up and dropped off. Also, when moving containers, sway in the vehicle or grappler can cause delays in container moving operations, or may even result in collision damage. It is desirable to control this sway motion to speed up container movement operations.

### SUMMARY OF THE INVENTION

These and other drawbacks in the prior art are overcome in large part by a system and method according to embodiments of the present invention.

A gantry crane system according to an embodiment of the present invention includes a frame structure having a plurality of vertical support legs and one or more members interconnecting predetermined pairs of the vertical support legs; and a positioning system including positioning sensors mounted to the frame structure and configured to receive positioning signals from positioning transmitters and a position processing unit configured to use the positioning signals to determine a deflection from vertical of at least one of the vertical support legs. In certain embodiments, the gantry crane system further includes a grappler assembly mounted to the frame structure. The position processing unit is configured to use positioning signals to determine a location of the grappler assembly.

A gantry crane system according to another embodiment of the present invention includes a frame assembly and a positioning system including at least one positioning sensor mounted to the frame assembly and configured to receive positioning signals; and a position processing unit configured to use said positioning signals to determine a sway deflection from a predetermined reference of at least a portion of said frame assembly. In other embodiments, the system further includes a base station having at least one base station positioning sensor and configured to communicate with said positioning system to determine a position of the frame assembly relative to the base station. The system may further include a grappler assembly mounted to the frame structure and wherein the position processing unit is configured to use positioning signals to determine a location of the grappler assembly.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates a gantry crane according to an embodiment of the present invention.

FIG. 2 illustrates an exemplary positioning system including a gantry crane according to an embodiment of the present invention.

FIG. 3A-FIG. 3D illustrate use of GPS antennas to determine sway and heading.

FIG. 4A and FIG. 4B are block diagrams illustrating exemplary location detection systems according to embodiments of the present invention.

FIG. 5 is a flowchart illustrating operation of an emboidmnet of the present invention.

FIG. 6 illustrates determination of gantry and grappler sway according to an embodiment of the present invetnion.

FIG. 7A-FIG. 7B illustrate grappler position sensors according to embodiments of the present invention.

FIG. 8A and FIG. 8B are flowcharts illustrating operation of embdoiments of the present invention.

FIG. 9 is a diagram of a gantry crane system according to an embodiment of the present invention.

FIG. 10 is a block diagram of a gantry crane location and control system according to an embodiment of the present invention.

FIG. 11A and FIG. 11B illustrate operation of a steering control system according to embodiments of the present invention.

FIG. 12 is a flowchart illustrating operation of an embodiment of the present invention.

FIG. 13 is a flowchart illustrating operation of an embodiment of the present invention.

### DETAILED DESCRIPTION OF EMBODIMENTS OF THE INVENTION

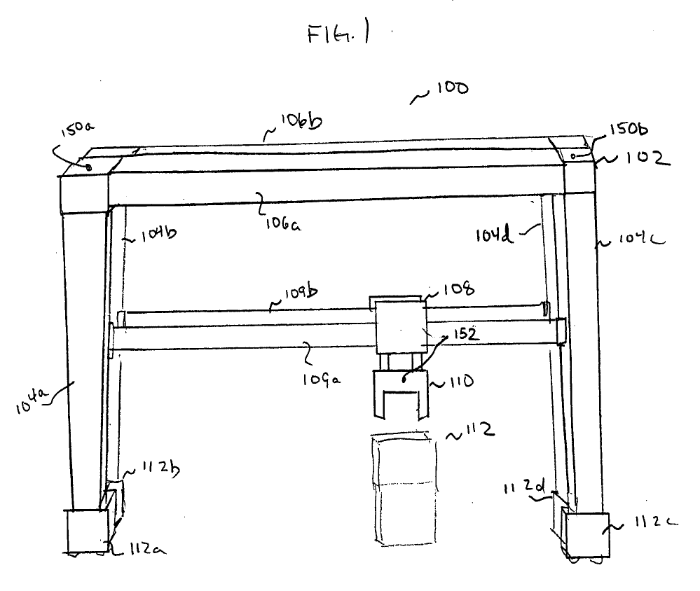

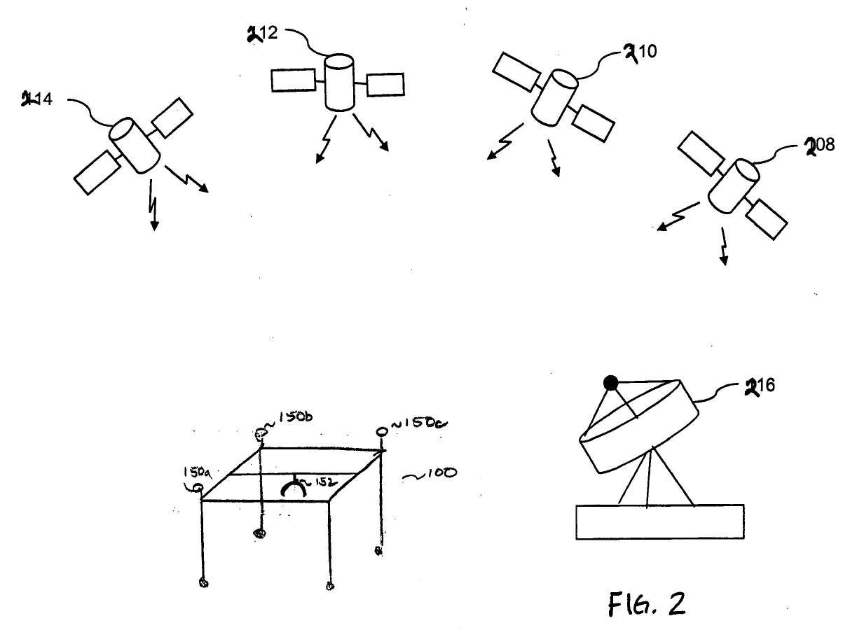

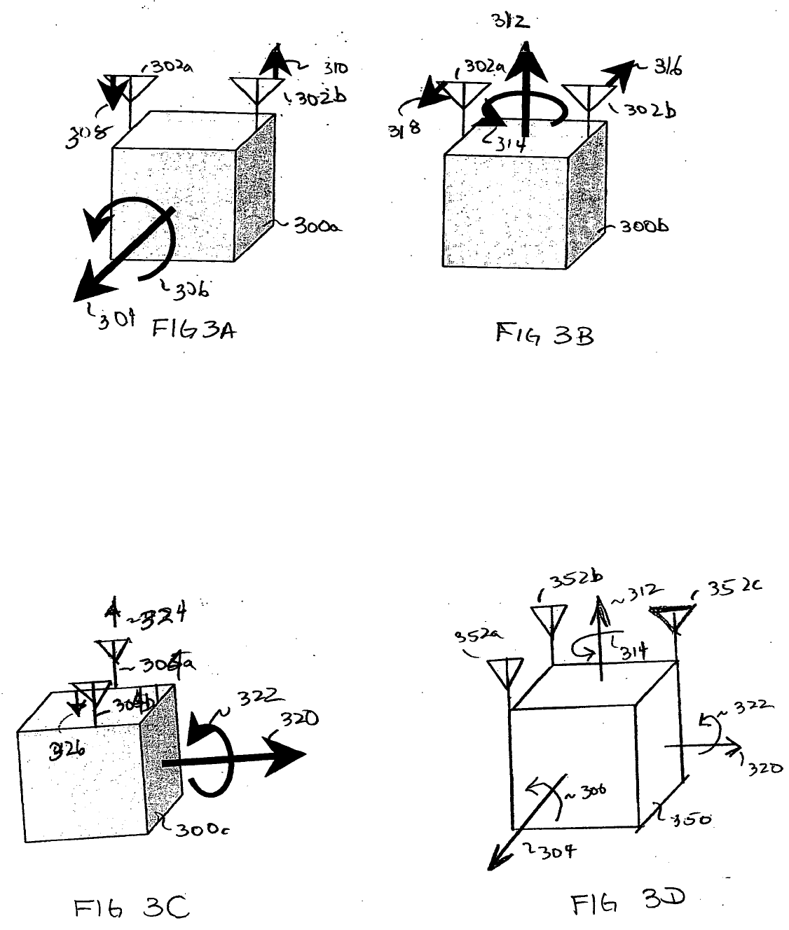

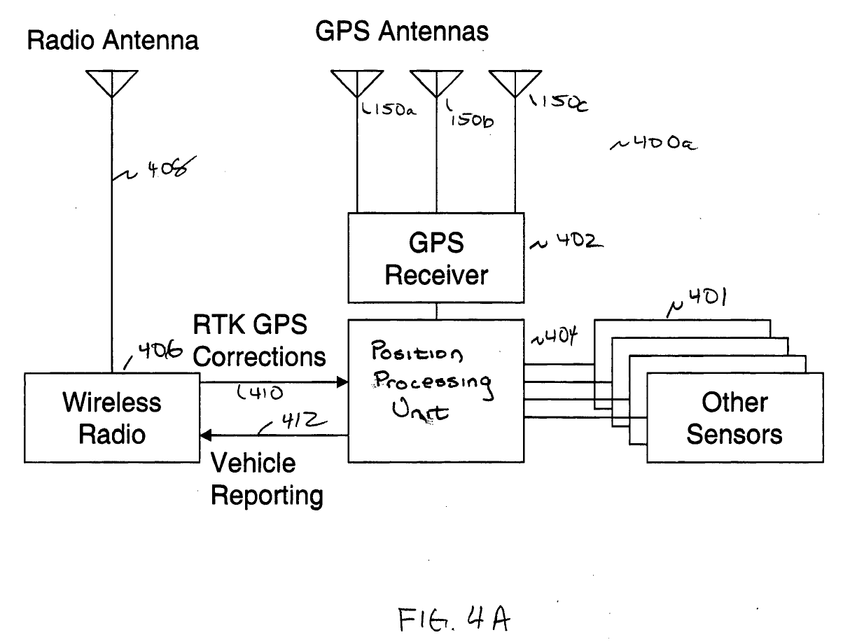

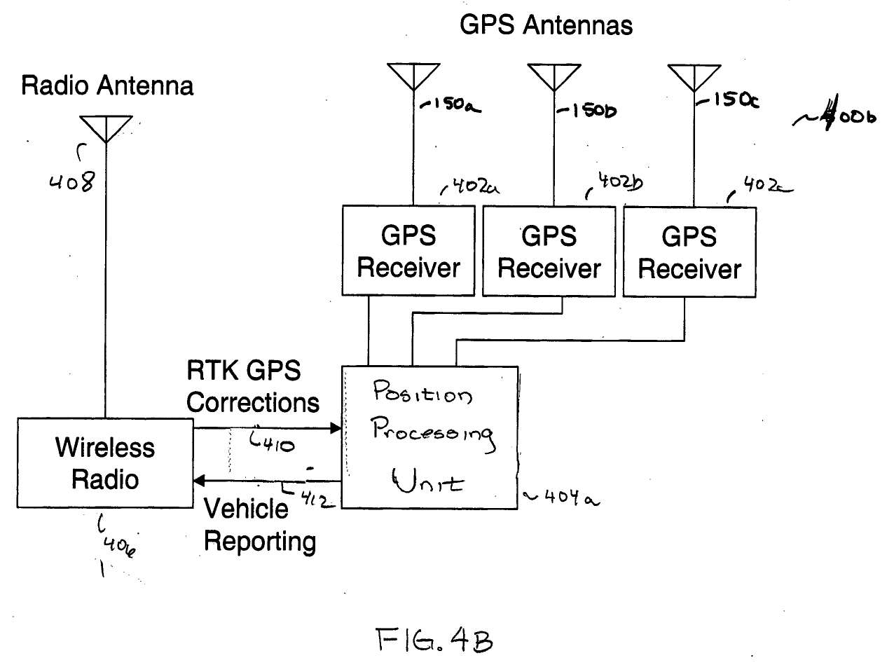

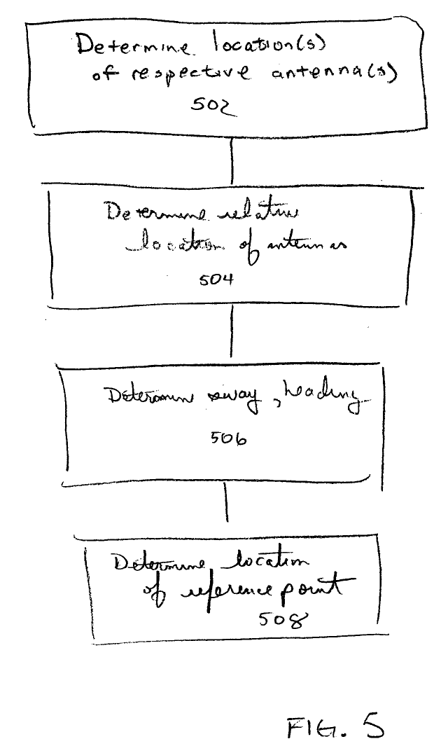

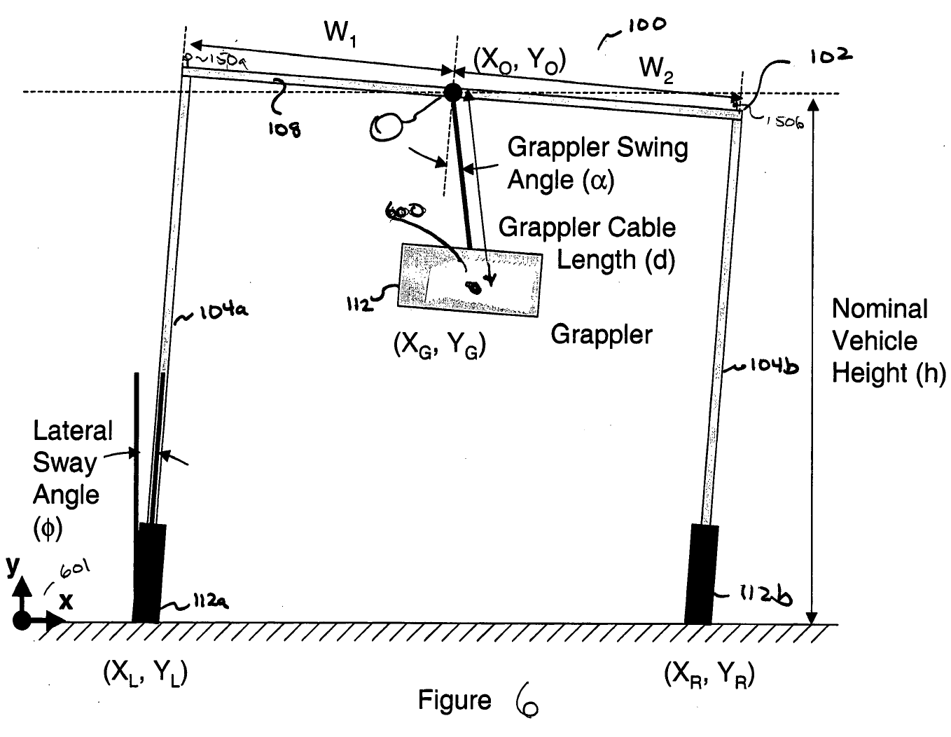

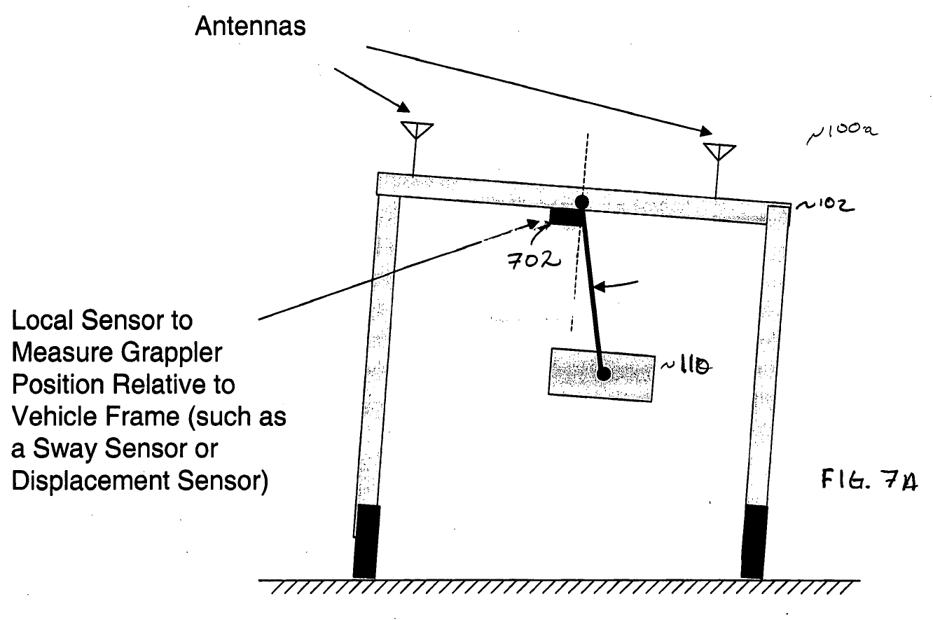

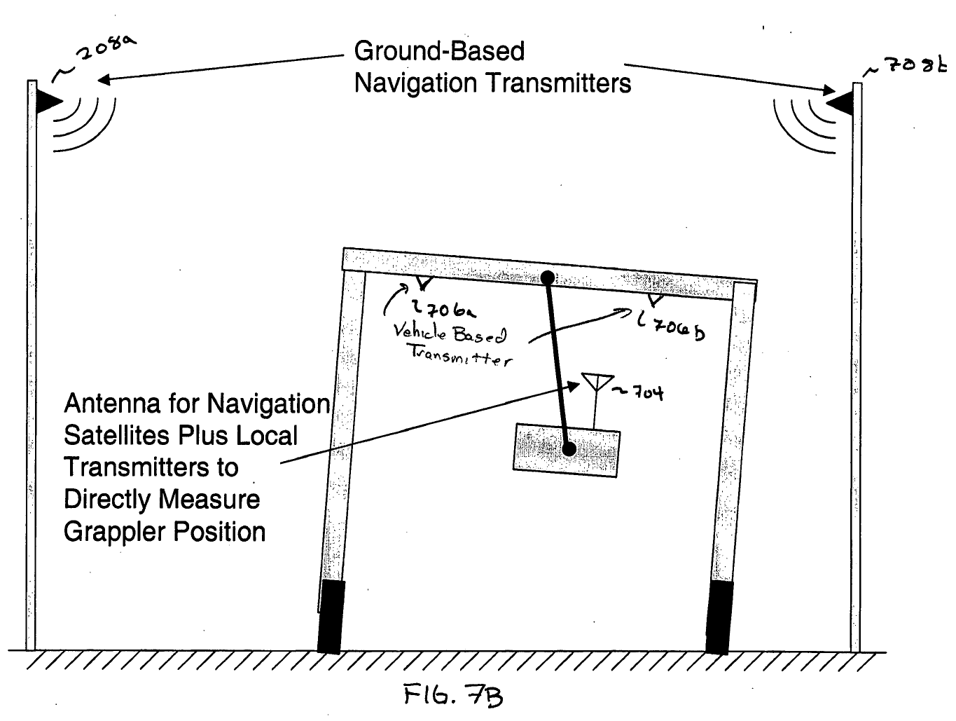

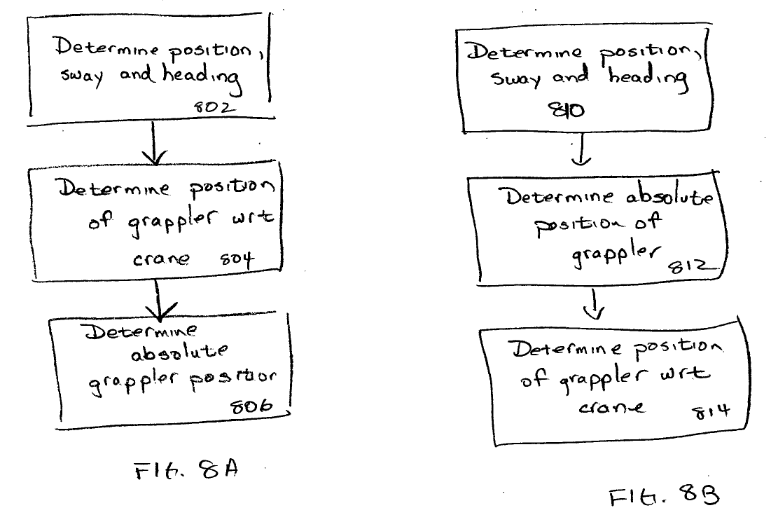

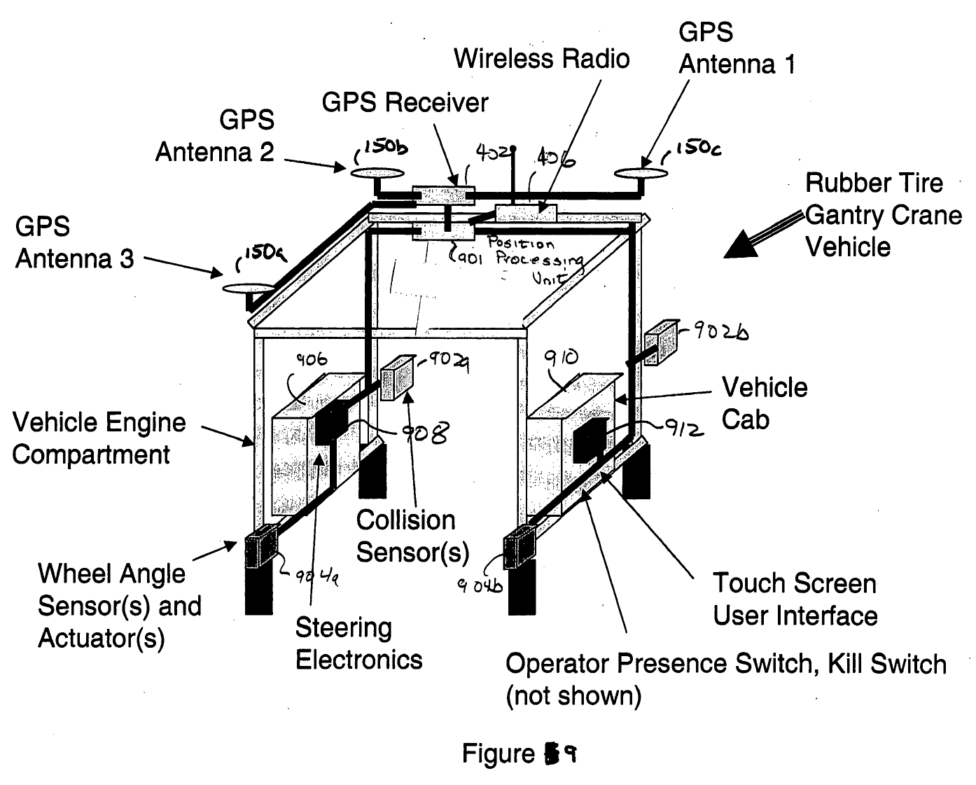

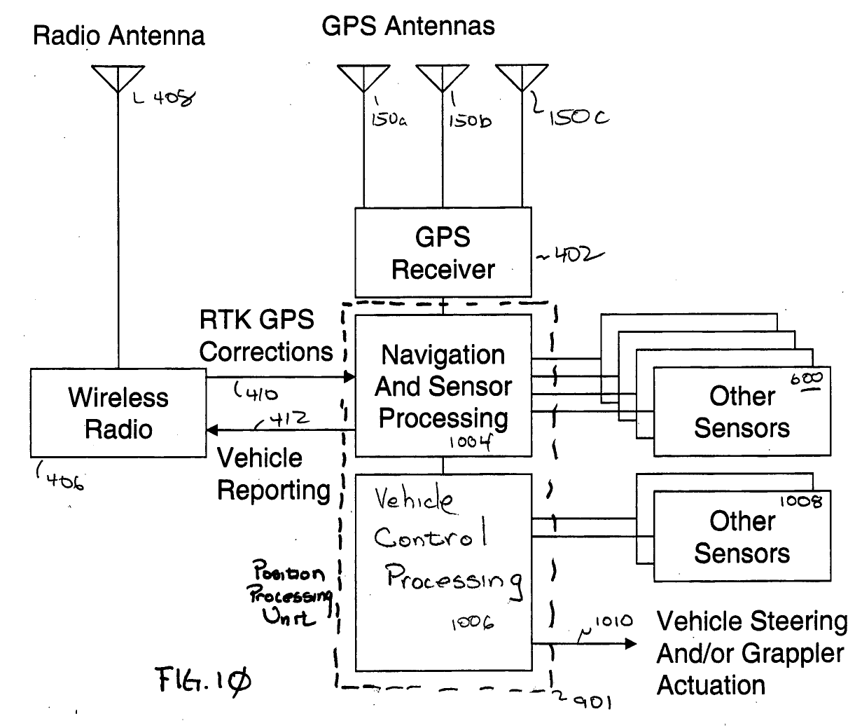

Turning now to the drawings and, with particular attention to FIG. 1, a gantry crane according to an embodiment of the present invention is shown and generally identified by the reference numeral 100. As shown, the gantry crane 100 includes a frame structure 102 having a plurality of vertical support members 104a-104d, and one or more interconnecting members 106a, 106b. A grappler assembly 108 is coupled to the frame 102 and is used to grasp, lift, and position containers 112. In the embodiment illustrated, the grappler assembly 108 includes horizontal members 109a, 109b, along which the grappler assembly 108 is moveable, and a grappler 110, suspended therefrom, and moveable vertically and horizontally.

In addition, in the embodiment illustrated, the gantry crane 100 is moveable on wheel assemblies 112a-112d, mounted at the ends of vertical members 104a-104d, respectively. In operation, the gantry crane 100 can be controlled to move into position to straddle and lift one or more containers 112, and carry them to a desired position. As will be explained in greater detail below, according to embodiments of the present invention, one or more position sensors 150a, 150b may be affixed to the frame 102 and used to determine location, heading, and/or lateral and longitudinal sway. Further, position sensors 152 may be associated with the grappler so as to determine its relative position with respect to the gantry frame.

In one embodiment of the invention, satellite signals from a global navigation satellite system (GNSS) are used to determine heading and sway, and to perform steering and grappler control. In particular, in one embodiment, signals from the Global Positioning System (GPS) are used. The GPS system nominally includes a constellation of twenty-four (24) satellites orbiting the earth in six (6) different orbital planes such that from any point on Earth, at least four satellites are visible at any instant in time. In addition to this, GPS also has control stations to monitor and maintain the orbit and clock-time of all the satellites. GPS satellites continuously emit low power radio signals that are received by GPS receivers on earth. A typical GPS implementation includes antennas for detecting the signals and a receiver for interpreting the signals. The receiver detects and decodes the GPS signals and returns the output to the user in a usable form. It is noted that, although the description mentions the use of GPS signals, it is apparent to one skilled in the art that the invention can make use of signals from other systems such as GLONASS, Galileo, pseudolites, Low Earth Orbiting (LEO) satellites, geosynchronous satellites such as WAAS, etc., to determine the position solution.

FIG. 2 is a schematic diagram of the general environment of the navigation and control system in accordance with an embodiment of the present invention. In the embodiment illustrated, position sensors 150a-150c, 152 are implemented as GPS antennas mounted on gantry crane 100.

As will be discussed in greater detail below, one or more GPS receivers may be attached to the gantry crane 100. The receivers receive signals from satellites 208, 210, 212, 214 via antennas 150a-150c. The antennas can be any standard antennas used in GPS receivers. In addition, the position sensor 152 may also be a GPS antenna, or any of a variety of other receivers or sensors. Four satellites 208, 210, 212 and 214 are shown in FIG. 2; the distances from the satellites are measured and the location of the antenna(s) are determined, e.g., by pseudoranging.

The system may also include a differential GPS (DGPS) reference station 216, in order to enhance the accuracy of the position solution. Use of a differential GPS reference station for both code and carrier phase positioning is well known in the art, for example, as described in “Differential GPS, in Global Positioning System: Theory and Applications II, volume 164” of Progress in Aeronautics and Astronautics, pp. 3-50 by Parkinson, Bradford W. and Enge, Per K., Editors. AIAA, 1996. Briefly, in certain embodiments, reference station 216 sends measurements of its own GPS position as well as code and carrier phases for each satellite in view via a data communication link to gantry crane 100. The code phase information may be C/A code only or both C/A and P-code. Likewise, the carrier phase information may be for GPS L1 frequency only, or both L1 and L2 frequencies, as well as future improvements to GPS such as incorporation of additional frequencies, including L5. The GPS receiver(s) of gantry crane 100 use the information to calculate very high accuracy (cm-level) positions of reference points on gantry crane 100, with respect to reference station 216.

As discussed above, embodiments of the present invention may be used to determine position, lateral sway, longitudinal sway, and vehicle heading. In particular, FIG. 3A-FIG. 3D schematically illustrate use of the GPS antennas in various configurations according to embodiments of the present invention to determine lateral sway, longitudinal sway, and gantry crane heading. Shown in FIG. 3A is an object 300a (representative, e.g., of gantry crane 100) having antennas two 302a, 302b. Lateral sway is represented as rotation about axis 304, in the direction of arrow 306. In this case, antenna 302a moves in direction of arrow 308 and antenna 302b moves in direction of arrow 310. The positioning system of embodiments of the present invention detects the relative motion of the antenna 302a with respect to antenna 302b to determine lateral sway.

Similarly, FIG. 3B illustrates use of two antennas 302a, 302b on object 300b to measure heading. As shown, the object 300b rotates about axis 312 in direction of arrow 314. This causes antenna 302a to move in direction 318 and antenna 302b to move in direction 316. The positioning system of embodiments of the present invention detects the relative motion of the antenna 302a with respect to antenna 302b to determine heading.

FIG. 3C illustrates use of two antennas 304a, 304b to measure longitudinal sway. As shown, the object 300c rotates about axis 320 in direction 322. The antenna 304a moves in direction of arrow 324, while antenna 304b moves in direction of arrow 326. The positioning system of embodiments of the present invention detects the relative motion of the antenna 304a with respect to antenna 304b to determine longitudinal sway.

FIG. 3D illustrates another system employing three antennas to determine lateral sway, longitudinal sway, and heading. Shown is object 350 having antennas 352a, 352b, 352c. As shown, the three antennas define a plane, such that antennas 352a, 352b will have a relative motion when rotating about axis 320 (e.g., in direction 322); antennas 352b, 352c will have a relative motion when rotating about axis 312 (e.g., in direction 314); and antennas 352b, 352c will have a relative motion when rotating about axis 304 (e.g., in direction 306). It is noted that while two antennas are shown associated with each “degree of freedom” (i.e., lateral sway, longitudinal sway, and heading), more may be employed.

FIG. 4A and FIG. 4B are block diagrams illustrating systems according to embodiments of the present invention. As shown, the navigation system 400a of FIG. 4A includes a plurality of GPS antennas 150a, 150b, 150c, which may be positioned on the gantry crane to determine position, lateral sway, longitudinal sway, and heading (as shown in FIG. 3D). It is noted, however, that while three antennas are shown, other embodiments may have more or fewer as deemed appropriate. The GPS positioning signals from the GPS satellites are received at the GPS antennas 150a-150c and, particularly, GPS receiver 402. The GPS receiver 402 may be any GPS receiver capable of receiving GPS signals from the number of antennas implemented. An exemplary GPS receiver for receiving signals from multiple antennas is described in commonly-assigned, co-pending U.S. patent application Ser. No. 10/408,496, titled “Satellite Navigation System Using Multiple Antennas,” which is hereby incorporated by reference in its entirety as if fully set forth herein.

The signals from the GPS receiver 402 are provided to a position processing unit 404. The position processing unit 404 may be implemented as any of a variety of suitably programmed processors and/or application specific integrated circuits, and associated memory.

The position processing unit 404 receives the navigation signals and uses the GPS information to derive position, heading, and sway information, as will be described in greater detail below. In addition, the system may include a wireless radio 406 and antenna 408 for receiving position signals from the base station 216 (FIG. 2). As discussed above, the wireless radio 406 receives DGPS or RTK GPS signals 410 and provides them to the position processing unit 404, which can be used for correcting position information derived from the on-board antennas 150a-150c. Similarly, the position processing unit 404 provides the navigation information 412 to the radio 406, which can transmit it to an off-vehicle system or operator (not shown), such as via a wireless LAN (local area network). In addition, as will be described in greater detail below, the position processing unit 404 can receive inputs from other sensor 401, such as grappler sensors and the like.

FIG. 4B illustrates a similar navigation system 400b. The system 400b includes antennas 150a, 150b, 150c suitably positioned on the gantry crane. In this embodiment, each antenna 150a, 150b, 150c is provided with its own GPS receiver 402a, 402b, 402c, respectively. In this embodiment, the receivers may be distributed or positioned along the gantry crane 100 with the antennas, rather than centrally located as in the embodiment of FIG. 4A. Again, however, the GPS receiver signals are provided to a position processing unit 404A. The position processing unit 404A is similar to the position processing unit 404, although includes the interface capability of receiving the signals from the three independent GPS receivers (Again, although not shown in FIG. 4B, the position processing unit 404A may receive signals from other sensors analogous to sensor(s) 401 of FIG. 4A). The navigation system 400b may also include wireless radio 406 with antenna 408 for receiving RTK GPS corrections 410 and for transmitting vehicle information 412 to remote operators.

In operation, as shown in FIG. 5, the position processing unit 404 uses GPS signals to determine the locations of the respective antennas 150a-150c (step 502). As noted above, this can include the signals from the individual antennas, as well as RTK corrections received via the wireless radio. Once the locations of the respective antennas are determined, the relative positions of at least pairs of antennas can be observed (step 504). For example, if antennas 452a, 452b (FIG. 3D) are determined to be at different relative heights, then the presence of longitudinal sway will be identified. From the relative positions of the antennas, the position processing unit 404 can then determine the amount of sway and/or gantry crane heading (step 506). This may be expressed, for example, in terms of a sway angle. Once sway and/or heading are determined, the position processing unit 404 can determine the actual location of predetermined reference points (step 508), such as the gantry crane wheels. As will be described in greater detail below, the direction of the wheels and hence the vehicle's path of travel can then be controlled.

As noted above, one aspect of the present invention relates to determining the position of attached members. Rigidly attached points can be located using a simple coordinate transformation calculation. Points not rigidly attached, such as a grappler, may require additional sensors, which may themselves be implemented as GPS antennas and/or receivers or other types of sensor units.

FIG. 6 illustrates use of teachings of the present invention to determine the location of a flexibly attached member. In particular, FIG. 6 is a simplified (two-dimensional) diagram illustrating gantry and grappler sway. Shown is gantry 100 and gantry frame 102. Vertical supports 104a, 104b end in wheel assemblies 112a, 112b, respectively. An interconnecting member 108 couples the vertical members 104a, 104b. A grappler assembly including a grappler 112 is suspended from the interconnecting member 108. A plane perpendicular to the ground 601 defines an XY reference frame. If the gantry frame 102 were rigid, the vertical members 104a, 104b would be parallel the Y-axis. However, the vertical members 104a, 104b are, in fact, displaced from vertical by a sway angle φ. As illustrated, the angle is an angle of lateral sway; a similar angle of longitudinal sway would be in the direction perpendicular the page. It is contemplated that two GPS antennas 150a, 150b may be used to determine lateral sway.

The location of the point O (Xo, Yo) on the top of the gantry crane and the lateral sway angle φ are found based on GPS measurements as discussed above. Further, the location of the point O relative to the crane (which may be pre-surveyed and stored in a memory (not shown)) is known to be distance W1 from the left reference and W2 from the right reference, and h above ground when the crane is level. The location of the left and right references (e.g., the wheels) can then be computed as a function of the known quantities Xo, W1, W2, h, and φ:
X_{L}=Xo−W₁ cos(φ)−h sin(φ)
X_{R}=Xo+W₂ cos(φ)−h sin(φ)

Similarly, an object that can be positioned accurately relative to the crane can be positioned with respect to inertial space by using the GPS measurements described above. For example, a sensor may be used to determine the relative grappler swing angle a; the relative grappler length d may be previously known, or may be measured by placing a sensor on the device which raises and lowers the grappler. The two-dimensional location of the grappler can then be found as a function of the known quantities Xo, Yo, α, φ, and d:
X_{G}=Xₒ+d sin(α−φ)
Y_{G}=Yₒ−d cos(α−φ)

The actual implementation of the sensor to determine grappler sway may take a variety of forms, as illustrated in FIGS. 7A-7B. In one embodiment, as shown in FIG. 7A, the grappler position sensor can be any suitable sway sensor or displacement sensor 702 fixed to directly detect the sway motion of the grappler. The output of the displacement sensor 702 is then an angle representative of the displacement of the grappler with respect to the body of the crane. The (X, Y) coordinate of the grappler can then be determined using the equations above. That is, the output of the displacement sensor 702 is then provided to the position processing unit, which can use the determination of gantry crane position and sway, in conjunction with the grappler sway, to determine the position of the grappler.

Note that FIG. 7A shows a gantry crane with a grappler that is suspended by cables that are free to swing. The above discussion regarding grappler positioning may be modified slightly for a grappler that is attached to a semi-rigid, movable beam, such as the gantry crane 100 shown in FIG. 1. In this case, sensors such as linear or rotational displacement sensors may be used to determine the vertical location of the beam relative to the vehicle, and the horizontal location of the grappler relative to the beam. Sensors such as a linear potentiometer or encoder may be physically attached to the grappler. Other sensors, such as a rotational sensor or encoder, may be physically attached to a chain sprocket or cable guide,. Still other sensors, such as a laser range finder may use indirect means to measure distances,. These are just a few examples, and various other implementations should be evident to one skilled in the art.

In other embodiments, the grappler sensor may be implemented as a navigation signal antenna 704 (FIG. 7B). For example, the navigation signal antenna 704 could be implemented as a GPS signal antenna. In other embodiments, however, the antenna 704 could alternatively or additionally receive navigation signals from local transmitters. For example, the gantry crane 100 could itself be provided with one or more navigation transmitters 706a, 706b, transmitting signals from known positions on the crane. Alternatively, navigation transmitters 708a, 708b could be provided at fixed positions in the container handling yard. The grappler position can then be directly determined and used in conjunction with gantry crane position, sway, etc., to determine the grappler sway angle for control purposes. This configuration could alternatively be reversed, with a navigation transmitter on the grappler, and navigation receivers on the gantry itself or at fixed positions in the container handling yard. This configuration could also be implemented with two or more antennas on the grappler in order to measure one or more axes of orientation of the grappler, in a manner similar to that illustrated in FIGS. 3A-3D.

In operation, as shown in FIG. 8A, a system according to embodiments of the present invention determines a gantry crane position and/or sway and heading (Step 802), using the GPS techniques described above. In particular, a position processing unit 404, such as described above, receives navigation data from one or more GPS receivers and processes the data to determine position, sway, and heading. The system also determines a grappler position with respect to the crane (step 804). That is, the position processing unit 404 receives the input from a grappler position sensor such as sensor 702 (FIG. 7A), which is used to determine the grappler angle. Once the grappler angle is determined, the position processing unit 404 can determine the inertial (X, Y) coordinate of the grappler, as described above.

In another embodiment, the grappler position is measured directly, as shown in the flowchart of FIG. 8B, and the position with respect to the gantry crane determined therefrom. For example, the position processing unit 404 can determine the vehicle position, sway, and heading, as discussed above (step 810). The position processing unit 404 can then receive position information about the grappler, e.g., via sensors 706a, 706b or 708a, 708b (step 812). From this and the gantry crane position information, the position processing unit 404 can determine the grappler angle with respect to the crane (Step 814).

It is noted that, while specific sensors have been shown, the sensors may include inertial sensors such as gyros and accelerometers; radiofrequency location tags; radar altimeters; laser range detectors; optical detectors; or pseudolite transmitters that may be placed on the vehicle or the grappler. Thus, the figures are exemplary only.

One aspect of embodiments of the present invention relates to an integrated positioning and gantry crane control system. As will be explained in greater detail below, the position, sway, and heading information can be used to guide and steer the gantry crane. Additionally, the grappler position information can be used to guide the grappler.

An exemplary integrated positioning and gantry crane control system is shown in FIG. 9. In the embodiment illustrated, the gantry crane 100 is a rubber tire gantry crane. The gantry crane 100 includes a position processing unit 901 which may include navigation, sensor, and vehicle control processing as will be explained in greater detail below. It is noted that the gantry crane may be implemented as other types of gantry cranes and that more or fewer vehicle control sensors may be employed. The position processing unit 901 may be implemented as one or more suitably programmed processors or application specific integrated circuits, including associated memory.

The position processing unit 901 couples to GPS receiver 402 and wireless radio 406, which receives signals via antenna, 408. The GPS receiver 402 receives GPS signals via GPS receivers 150a-150c. The position processing unit 901 may be coupled via a standard wired connection, such as RS-232, USB, Ethernet, etc. Alternatively, a wireless interface such as IEEE 802.11 may provide the link.

The gantry crane 100 further includes a plurality of collision sensors 902a, 902b and a plurality of wheel angle sensors 904a, 904b. The collision sensors 902a, 902b may be known collision sensors that detect proximity of the gantry crane to other objects. Typically, the collision sensors would be located on all four corners of the vehicle. Only two collision sensor are shown in order to simplify the drawing. Similarly, the wheel angle sensors and actuators 904a, 904b may be known wheel angle sensors and actuators and are used to determine and control, e.g., the direction of the wheels. Thus, the gantry crane can be guided on a non-straight path, as will be described in greater detail below.

It is noted that the grappler assembly 108 and grappler 110 (FIG. 1) are omitted for clarity; however, the position processing unit 901 can couple to the grappler assembly 108 and grappler 110 to determine the position of, and control the operation of, the grappler.

The gantry crane 100 also includes a vehicle engine compartment 906 with steering electronics 908 for controlling, e.g., the vehicle heading and path of travel. Such steering electronics 908 may couple, for example, to control the range of motion of the wheel actuators to control wheel angle. A vehicle cab 910 includes vehicle controls (e.g., steering wheel or joystick) and a touch screen user interface (not shown) coupled to the position processing unit 901 and the steering electronics 908. The user is able to engage or disengage the steering system, select the desired path, calibrate, fine tune, troubleshoot, and communicate, all through the touch screen user display.

The gantry crane control and positioning system of FIG. 9 is illustrated in block diagram form in FIG. 10. As shown, the system includes a position processing unit 901 including a navigation and sensing processing unit 1004 and a vehicle control processing unit 1006. The navigation and sensor processor 1004 is coupled to the GPS receiver 402 for receiving position information via antennas 150a-150c. The navigation and sensor processor also receives RTK GPS corrections 410 via wireless radio 406, in a manner similar to that described above. Sensors 600, such as grappler sensors, also provide position information to the navigation and sensor processor 1004.

Navigation and position processing control signals are provided from the navigation and sensor processor 1004 to a vehicle control system processing unit 1006. The vehicle control system processing unit 1006 also receives inputs from sensors 1008, such as the wheel sensors 904 and collision sensors 902 (FIG. 9). Information from collision sensors 902 and other safety devices can be used to alert the user and/or disengage the steering system if an unsafe vehicle condition occurs. It is noted that additional vehicle control sensors may be provided as the implementation warrants. These may include, for example, joystick or steering wheel position sensors; operator presence sensors; throttle input sensors; operator presence sensors; and the like.

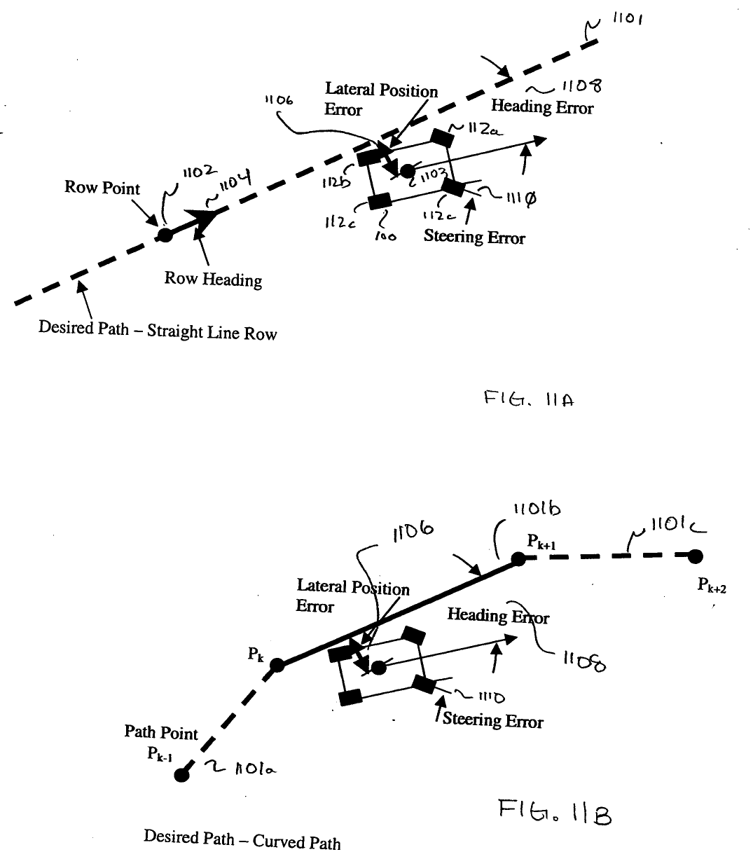

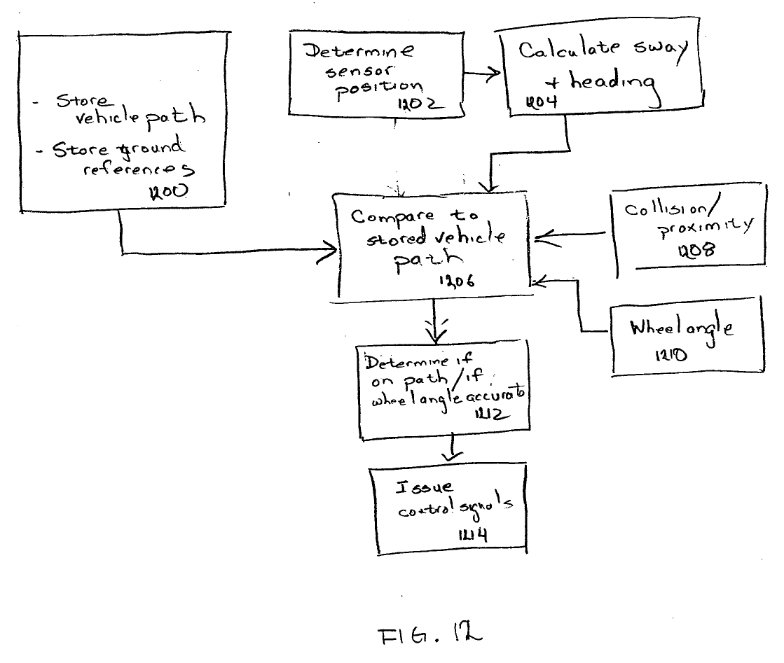

In operation, the position processing unit 901 receives inputs from the GPS receiver 402 and the wireless radio 406 and computes the position, heading, and sway of the gantry crane 100. The position processing unit 901 then determines the location of the gantry crane tires 112. The tire locations are compared to desired tire locations, which are stored, accessible by the control processor 1006, in a database of desired tire paths. From this, lateral position error and heading error may be computed. The position processing unit 901 also receives inputs from a wheel angle sensor 904 and computes a wheel angle error. (These are described in greater detail below, with reference to FIG. 11A and FIG. 11B.).

These three values, along with feed-forward information about the desired path, are used to compute a desired wheel angle rate command, which is transmitted by the control system processor 1006 at 1010 to the wheel actuators. This command may be proportional or on-off (bang-bang), depending on the nature of the vehicle steering system.

Similarly, the navigation and sensor processing unit 1004 receives grappler position information from sensors 600 and determines the grappler position relative to the gantry crane and also absolutely. This information can be compared to the desired stored position and used to generate commands that will restore the grappler to the desired position.

FIG. 11A and FIG. 11B illustrate exemplary operation of the vehicle control processing unit 1006.

One method for defining a vehicle path is shown in FIG. 11A. Shown is a desired path 1101, typically programmed into the vehicle control processing unit 1006's memory. The path can be defined by two position points or, as shown, by a position point 1102 and a heading 1104. Shown also is an exemplary gantry crane 100 with wheels 112a-112d.

A reference point 1103 on the gantry crane is used to determine position errors. In particular, a lateral position error 1106 is the distance between the reference point 1103 and the desired path 1101, defined by the point 1102 and heading 1104. Similarly, heading error 1108 is the angle between actual heading and the desired path. Finally, a steering error 1110 is defined as the angle between actual physical wheel angle and desired physical wheel angle. Vehicle heading, position, and wheel angle can be determined using the methods described herein, and the various error terms derived therefrom.

In some gantry cranes, steering is performed by altering the speed of the wheels on either side of the vehicle, rather than by physically turning the wheels. In such cases, the wheel speeds may be estimated using GPS, or a wheel speed sensor may be used to generate a steering measurement.

While FIG. 1 1A illustrates a straight line path, the invention may be used in association with an arbitrary curved path. The path may be defined by one or more equations, or by a series of position points defining straight segments stored in memory. The points may be determined through any of a variety of methods, such as driving a vehicle over the path while storing GPS data; using existing surveys of the path; extracting path information from design documents of the yard; or taking aerial photographs of the path.

FIG. 11B illustrates use of individual line segments to define a curved vehicle path. Shown are a plurality of path points Pₖ₋₁, Pₖ, Pₖ₊₁, and Pₖ₊₂. Consecutive path points define the path segments the gantry crane is to follow. Thus, shown are path segments 1101a, 1101b, 1101c. As shown, the gantry crane 100 is traversing path segment 1101b. Within each segment, a lateral position error 1106, heading error 1108, and steering error 1110 are defined in a manner similar to that discussed above with reference to FIG. 11A. Steering control for each segment can proceed as discussed above for the straight line case.

It is noted that other methods of parameterizing a curved path could be employed. For example, rather than a plurality of straight line segments, a spline curve could be fitted to the position points and the vehicle position, sway, heading, and steering wheel angle could be compared to the curve. Thus, the figures are exemplary only.

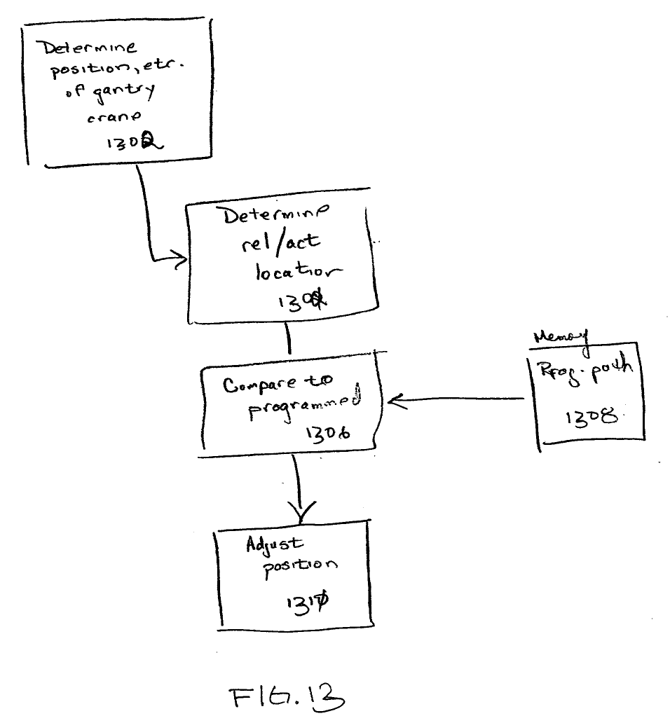

Operation of the system of FIG. 10 to control gantry crane path of travel is shown more clearly with reference to FIG. 12. At 1200, the position processing unit 901 stores a desired vehicle path. As noted above, such a path can be used to guide the vehicle and used to compare the actual position of the vehicle. A ground reference may also be stored. The gantry crane 100 can then operate along its programmed path, with its position being determined at periodic intervals. In particular, at 1202, the position of the positioning sensors 150a-150c is determined, as described above. From this, the position processing unit 901 determines vehicle sway and heading, at 1204. The position processing unit 901 then compares the measured position to the stored path of travel, at 1206. The position processing unit further receives inputs from the collision/proximity detectors (step 1208) and the wheel angle sensors (step 1210). The position processing unit 901 then determines if the gantry crane is on the correct path, and can evaluate a heading error, and lateral position error, for example, at step 1212. The system also determines the correct wheel angle needed to maintain or restore the gantry crane to the correct path. Appropriate control signals can be issued by the vehicle control processing unit at 1214.

Operation of the system of FIG. 10 to control gantry crane path of travel is shown more clearly with reference to FIG. 13. At 1300, the position processing unit 901 determines vehicle position, sway, heading, etc., of the gantry crane, for example using the techniques described above. At step 1304, position processing unit 901 determines the position (and/or orientation) of the grappler, for example, as described above. The grappler position is then compared at a step 1306 to a position that had been stored in memory at 1308. If the grappler has deviated from the desired position, the vehicle control processing unit 1006 can issue suitable commands to adjust the grappler position, in step 1310.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

1. A gantry crane system, comprising:
a frame structure, the frame structure having a plurality of vertical support legs and one or more members interconnecting predetermined pairs of the vertical support legs;
a positioning system including positioning sensors mounted to the frame structure and configured to receive positioning signals from positioning transmitters and a position processing unit configured to use said positioning signals to determine a deflection from vertical of at least one of the vertical support legs.

2. A gantry crane system in accordance with claim 1, wherein said deflection from vertical comprises lateral sway.

3. A gantry crane system in accordance with claim 1, wherein said deflection from vertical comprises longitudinal sway.

4. A gantry crane system in accordance with claim 1, said position processing unit further configured to use said positioning signals to determine a heading of said frame structure.

5. A gantry crane system in accordance with claim 4, further including a vehicle control unit operably coupled to receive navigation signals from said position processing unit and configured to steer said frame structure along a predetermined path of travel responsive to said navigation signals.

6. A gantry crane system in accordance with claim 1, further including a grappler assembly mounted to the frame structure and wherein the position processing unit is configured to use positioning signals from a positioning sensor associated with the grappler to determine a location of the grappler assembly.

7. A gantry crane system in accordance with claim 1, further including a grappler assembly mounted to the frame structure and wherein the position processing unit is configured to use positioning signals from a plurality of positioning sensors associated with the grappler to determine a location and orientation of the grappler assembly.

8. A gantry crane system in accordance with claim 6, including a vehicle control unit adapted to receive navigation control signals from said position processing unit responsive to a position of said grappler and use said navigation control signals to control a position of the grappler assembly.

9. A gantry crane system in accordance with claim 1, further including a base station, the base station including at least one base station positioning sensor and configured to communicate with said positioning system to determine a position of the frame assembly relative to the base station.

10. A gantry crane system in accordance with claim 1, wherein said positioning system comprises a satellite navigation positioning system and the positioning sensors comprise satellite navigation positioning system antennas.

11. A gantry crane system in accordance with claim 1, wherein said positioning system comprises a navigation positioning system including ground-based navigation signal transmitters and the positioning sensors comprise navigation positioning system antennas.

12. A gantry crane system in accordance with claim 2, wherein if O having coordinates (Xo, Yo) identifies a point on an interconnecting member; φ identifies a lateral sway angle; W₁ and W₂ identify absolute distances of point O from left and right references; and h identifies a height of point O above an absolute reference, then the actual lateral location of points L and R of predetermined points on respective vertical support legs is given by
X_{L}=Xₒ−W₁ cos φ−h sin φ
X_{R}=Xₒ−W₂ cos φ−h sin φ

13. A gantry crane system in accordance with claim 6, wherein if a relative grappler swing angle of a grappler assembly having length d and mounted from a point O having coordinates (Xₒ, Yₒ) is given by α; and φ identifies a lateral sway angle; then a lateral position (X_{G}, Y_{G}) of said grappler assembly is given by
X_{G}=Xₒ+d sin(α−φ)
Y_{G}=Yₒ−d cos(α−φ)

14. A gantry crane system, comprising:
a frame assembly;
a positioning system including positioning sensors mounted to the frame assembly and configured to receive positioning signals and a positioning processor configured to use said positioning signals to determine a sway deflection from a predetermined reference of at least a portion of said frame assembly.

15. A gantry crane system in accordance with claim 14, wherein said positioning processor is configured to use said positioning signals to determine a location and a path of travel of said frame structure

16. A gantry crane system in accordance with claim 14, further comprising a grappler assembly mounted to the frame, said grappler assembly including a grappler position sensor, wherein said positioning processor is adapted to determine a grappler swing angle of said grappler assembly relative said frame assembly.

17. A gantry crane system in accordance with claim 14, wherein said positioning system includes a global navigation satellite system (GNSS) receiver, and the positioning sensors comprise at least one GNSS antenna.

18. A gantry crane system in accordance with claim 14, wherein said positioning system comprises a navigation positioning system including ground-based navigation signal transmitters and the positioning sensors comprise navigation positioning system antennas

19. A gantry crane system in accordance with claim 14, further including a steering system operably coupled to said positioning system and configured to automatically correct a path of travel of said gantry assembly.

20. A gantry crane system in accordance with claim 16, further comprising a control unit configured to use said grappler swing angle to control a new position of said grappler.

21. A gantry crane system in accordance with claim 14, wherein if O having coordinates (Xo, Yo) identifies a point on a horizontal frame member; φ identifies a lateral sway angle; W₁ and W₂ identify absolute distances of point O from left and right frame references; and h identifies a height of point O on said frame assembly above an absolute reference, then the actual lateral location of points L and R of predetermined points on respective frame assembly vertical support legs is given by
X_{L}=Xₒ−W₁ cos φ−h sin φ
X_{R}=Xₒ−W₂ cos φ−h sin φ

22. A gantry crane system in accordance with claim 16, wherein if a relative grappler swing angle of a grappler assembly having length d and mounted from a point O having coordinates (Xₒ, Yₒ) is given by a; and φ identifies a lateral sway angle; then a lateral position (X_{G}, Y_{G}) of said grappler assembly is given by
X_{G}=Xₒ+d sin(α−φ)
Y_{G}=Yₒ−d cos(α−φ)

23. A gantry crane system in accordance with claim 14, said sway deflection comprising lateral sway, said positioning processor further adapted to determine a gantry crane heading.

24. A gantry crane system in accordance with claim 14, said sway deflection comprising longitudinal sway, said positioning processor further adapted to determine a gantry crane heading.

25. A gantry crane system in accordance with claim 14, said positioning sensors comprising a plurality of global navigation satellite system (GNSS) antennas and said positioning processor comprising one GNSS receiver.

26. A gantry crane system in accordance with claim 25, said sway deflection comprising lateral sway, said positioning processor further adapted to determine a gantry crane heading.

27. A gantry crane system in accordance with claim 25, said sway deflection comprising longitudinal sway, said positioning processor further adapted to determine a gantry crane heading.

28. A gantry crane system in accordance with claim 25, said sway deflection comprising longitudinal and lateral sway, said positioning processor further adapted to determine a gantry crane heading.

29. A gantry crane system in accordance with claim 14, said positioning sensors comprising a plurality of global navigation satellite system (GNSS) antennas and said positioning processor comprising a plurality of GNSS receivers.

30. A gantry crane system in accordance with claim 29, said sway deflection comprising lateral sway, said positioning processor further adapted to determine a gantry crane heading.

31. A gantry crane system in accordance with claim 29, said sway deflection comprising longitudinal sway, said positioning processor further adapted to determine a gantry crane heading.

32. A gantry crane system in accordance with claim 29, said sway deflection comprising longitudinal and lateral sway, said positioning processor further adapted to determine a gantry crane heading.

33. A method for operating a gantry crane, comprising:
using a plurality of global navigation satellite system (GNSS) antennas mounted on a gantry frame to determine a sway of at least a portion of said gantry frame.

34. A method in accordance with claim 33, further comprising using said plurality of GNSS antennas to steer said gantry crane on a desired path.

35. A method in accordance with claim 33, wherein said using said plurality of GNSS antennas to determine a sway comprises using two GNSS antennas in conjunction with a single GNSS receiver.

36. A method in accordance with claim 33, wherein said using said plurality of GNSS antennas to determine a sway comprises using three or more GNSS antennas in conjunction with a single GNSS receiver and said sway comprises lateral and longitudinal sway.

37. A method in accordance with claim 33, further comprising using a remote GNSS antenna in conjunction with said mounted GNSS antennas to determine a location of the mounted GNSS antennas relative to said remote GNSS antenna.

38. A method in accordance with claim 33, further comprising using at least one GNSS antenna to determine a position of a flexibly-attached member.

39. A gantry crane system, comprising:
a frame structure, the frame structure having a plurality of vertical support legs and one or more members interconnecting predetermined pairs of the vertical support legs;
a positioning system including a plurality of positioning sensors mounted to the frame structure and configured to receive positioning signals from positioning transmitters and a position processing unit configured to use said positioning signals to determine a sway deflection of at least at least a portion of the frame structure; and
means coupled to said positioning system for steering said gantry crane.

40. A gantry crane system in accordance with claim 39, said steering means including means for steering said gantry crane on a non-straight path.

41. A gantry crane system in accordance with claim 40, further comprising a grappler assembly mounted to the frame structure, said grappler assembly including a grappler position sensor, wherein said positioning processor is adapted to determine a grappler swing angle of said grappler assembly relative said frame structure.

42. A gantry crane system in accordance with claim 41, said plurality of positioning sensors comprising a plurality of global navigation satellite system (GNSS) antennas and said positioning processor comprising a plurality of GNSS receivers.

43. A gantry crane system in accordance with claim 42, said sway deflection comprising lateral sway, said positioning processor further adapted to determine a gantry crane heading.

44. A gantry crane system in accordance with claim 43, said sway deflection comprising longitudinal sway, said positioning processor further adapted to determine a gantry crane heading.

45. A gantry crane system in accordance with claim 43, said sway deflection comprising lateral sway and longitudinal sway, said positioning processor further adapted to determine a gantry crane heading.

46. A gantry crane system in accordance with claim 41, said plurality of positioning sensors comprising a plurality of global navigation satellite system (GNSS) antennas and said positioning processor comprising one GNSS receiver.

47. A gantry crane system in accordance with claim 46, said sway deflection comprising lateral sway, said positioning processor further adapted to determine a gantry crane heading.

48. A gantry crane system in accordance with claim 46, said sway deflection comprising longitudinal sway, said positioning processor further adapted to determine a gantry crane heading.

49. A gantry crane system in accordance with claim 46, said sway deflection comprising longitudinal and lateral sway, said positioning processor further adapted to determine a gantry crane heading.

50. A method for operating a gantry crane, comprising:
using a plurality of navigation system antennas mounted on a gantry frame to determine a sway of at least a portion of said gantry frame.

51. A method in accordance with claim 50, further comprising using said plurality of navigation system antennas to steer said gantry crane on a desired path.

52. A method in accordance with claim 50, wherein said using said plurality of navigation system antennas to determine a sway comprises using two navigation system antennas in conjunction with a single navigation system receiver.

53. A method in accordance with claim 50, wherein said using said plurality of navigation system antennas to determine a sway comprises using three or more navigation system antennas in conjunction with a single navigation system receiver and said sway comprises lateral and longitudinal sway.

54. A method in accordance with claim 50, further comprising using a remote navigation system antenna in conjunction with said mounted navigation system antennas to determine a location of the mounted navigation system antennas relative said remote navigation system antenna.

55. A method in accordance with claim 50, further comprising using at least one navigation system antenna to determine a position of a flexibly-attached member.

56. A method in accordance with claim 55, wherein said using at least one navigation system antenna to determine a position of a flexibly-attached member comprises receiving navigation signals from a ground-based navigation signal transmitter.

57. A method in accordance with claim 55, wherein said using at least one navigation system antenna to determine a position of a flexibly-attached member comprises receiving navigation signals from a vehicle-based navigation signal transmitter.
